(19) United States
(12) Patent Application Publication
(10) Pub. No.: US 2021/0265633 A1
(43) Pub. Date: Aug. 26, 2021

(54) CARBON MATERIAL, CONDUCTIVE AID, ELECTRODE FOR POWER STORAGE DEVICE, AND POWER STORAGE DEVICE

(71) Applicant: SEKISUI CHEMICAL CO., LTD., Osaka (JP)

(72) Inventors: Kazuho UCHIDA, Osaka (JP); Akihiko FUJIWARA, Osaka (JP); Hiroki MASUDA, Osaka (JP); Yuuki SAWADA, Osaka (JP)

(73) Assignee: SEKISUI CHEMICAL CO., LTD., Osaka (JP)

(21) Appl. No.: 17/252,526

(22) PCT Filed: Jun. 19, 2019
(86) PCT No.: PCT/JP2019/024307

§ 371 Date: Dec. 15, 2020

(30) Foreign Application Priority Data
Jun. 25, 2018 (JP) 2018-119943

(51) Int. Cl. H01M 4/62; C01B 32/182

(52) U.S. Cl. CPC H01M 4/625; C01B 32/182; C01P 2002/88; C01P 2006/12; C01P 2006/40

(57) ABSTRACT

There is provided a carbon material capable of enhancing the capacity of a power storage device and battery characteristics such as rate characteristics and cycle characteristics. The carbon material is one having a graphene layered structure, in which: a BET specific surface area of the carbon material is 1 m²/g or more and 25 m²/g or less; and when a particle concentration of the carbon material and an integrated value of particle areas of the carbon material are measured by a flow-type particle image analyzer using an N-methyl-2-pyrrolidone solution containing 20 ppm of the carbon material, the particle concentration of the carbon material is 3,000 particles/μL or more and 50,000 particles/μL or less, and the integrated value of the particle areas of the carbon material is 1,000 mm²/mg or more and 10,000 mm²/mg or less.

### TECHNICAL FIELD

The present invention relates to a carbon material having a graphene layered structure, a conductive aid using the carbon material, an electrode for a power storage device, and a power storage device.

### BACKGROUND ART

In recent years, research and development of power storage devices have been actively conducted for mobile devices, hybrid vehicles, electric vehicles, household power storage applications, and the like. As electrode materials for power storage devices, carbon materials such as graphite, activated carbon, carbon nanofibers, and carbon nanotubes are widely used from an environmental aspect.

The following Patent Document 1 discloses a non-aqueous electrolyte secondary battery using, in the positive electrode, a composite of a compound represented by the general formula LiₓFePO₄ and a carbon material. Patent Document 1 describes that an amorphous carbon material such as acetylene black is preferably used as the carbon material.

Further, the following Patent Document 2 discloses a non-aqueous electrolyte secondary battery using, in the positive electrode, porous carbon having pores having a three-dimensional network structure.

### RELATED ART DOCUMENTS

### Patent Documents

Patent Document 1: JP 2002-110162 A

Patent Document 2: WO 2016/143423 A

### SUMMARY OF THE INVENTION

### Problems to be Solved by the Invention

In recent years, power storage devices having more excellent battery characteristics have been increasingly developed for applications such as hybrid vehicles and electric vehicles. However, in a power storage device using, in the electrode, a carbon material as in Patent Document 1 or Patent Document 2, a capacity and battery characteristics such as rate characteristics and cycle characteristics are still insufficient.

An object of the present invention is to provide a carbon material, a conductive aid using the carbon material, an electrode for a power storage device, and a power storage device capable of enhancing the capacity of a power storage device, and battery characteristics such as rate characteristics and cycle characteristics.

### Means for Solving the Problems

As a result of diligent studies, the inventors of the present application have found that the above-mentioned problems can be solved by setting, in a carbon material having a graphene layered structure, a BET specific surface area so as to be within a specific range, and by setting a particle concentration of the carbon material and an integrated value of particle areas of the carbon material, which are measured by a flow-type particle image analyzer using an N-methyl-2-pyrrolidone solution containing 20 ppm of the carbon material, so as to be within specific ranges; and have accomplished the present invention.

That is, the carbon material according to the present invention is a carbon material having a graphene layered structure, in which: a BET specific surface area of the carbon material is 1 m²/g or more and 25 m²/g or less; and when a particle concentration of the carbon material and an integrated value of particle areas of the carbon material are measured by a flow-type particle image analyzer using an N-methyl-2-pyrrolidone solution containing 20 ppm of the carbon material, the particle concentration of the carbon material is 3,000 particles/μL or more and 50,000 particles/μL or less, and the integrated value of the particle areas of the carbon material is 1,000 mm²/mg or more and 10,000 mm²/mg or less.

In a specific aspect of the carbon material according to the present invention, the carbon material, when subjected to a differential thermal analysis at a heating rate of 10° C./min, has an exothermic peak having a peak temperature of 700° C. or lower.

In another specific aspect of the carbon material according to the present invention, the carbon material, when subjected to a differential thermal analysis at a heating rate of 10° C./min, has a first exothermic peak having a peak temperature of 500° C. or higher and 700° C. or lower and a second exothermic peak having a peak temperature of 400° C. or higher and 500° C. or lower. It is preferable that the content of a component derived from the second exothermic peak is 0.1% by weight or more and 10% by weight or less.

In still another specific aspect of the carbon material according to the present invention, the component derived from the second exothermic peak is a synthetic resin or a carbide of the synthetic resin. It is preferable that the synthetic resin contains an oxygen atom. It is more preferable that the synthetic resin is at least one selected from the group consisting of (meth)acrylic resin, vinyl acetate resin, polypropylene glycol resin, and polyethylene glycol resin.

In a more specific aspect of the carbon material according to the present invention, a powder resistance of the carbon material is 0.1 Ω·cm or less.

The conductive aid according to the present invention is a conductive aid to be used in the electrode of a power storage device, and contains the carbon material formed according to the present invention.

The electrode for a power storage device according to the present invention contains the conductive aid formed according to the present invention.

The power storage device according to the present invention includes the electrode for a power storage device formed according to the present invention.

### Effect of the Invention

According to the present invention, a carbon material, a conductive aid using the carbon material, an electrode for a power storage device, and a power storage device capable of enhancing the capacity of a power storage device, and battery characteristics such as rate characteristics and cycle characteristics, can be provided.

### Modes for Carrying Out the Invention

Hereinafter, details of the present invention will be described.

### [Carbon Material]

A carbon material according to the present invention is a carbon material having a graphene layered structure. The BET specific surface area of the carbon material is 1 m²/g or more and 25 m²/g or less. The particle concentration of the carbon material is 3,000 particles/μL or more and 50,000 particles/μL or less. The integrated value of the particle areas of the carbon material is 1,000 mm²/mg or more and 10,000 mm²/mg or less.

The particle concentration of the carbon material can be obtained by capturing a still image of the particles flowing in a flow cell with the use of, for example, a flow-type particle image analyzer (manufactured by Sysmex Corp., product number “FPIA-3000”) using an N-methyl-2-pyrrolidone solution containing 20 ppm of the carbon material, and then by measuring a particle concentration. The integrated value of the particle areas of the carbon material can be calculated by the following procedure. First, a particle area is calculated from an equivalent circle diameter that is the diameter of a circle having the same area as the projected area of a particle. Then, a product of the particle area and the number of the particles in each particle diameter (equivalent circle diameter) is calculated, and the products are added up for all particle diameters, thereby obtaining the integrated value.

In the present invention, the BET specific surface area of the carbon material is equal to or less than the above upper limit, and hence the conductivity of the carbon material is enhanced. From the viewpoint of enhancing the conductivity of a carbon material, as described above, it is desirable to reduce a BET specific surface area, but from the viewpoint of enhancing dispersibility or obtaining a good electron conduction path in the electrode of a power storage device, there has conventionally been a tendency in which a BET specific surface area is designed to be large. However, the present inventors have found that even if the BET specific surface area of a carbon material is as small as or less than the above upper limit, good dispersibility and a good electron conduction path can be obtained by setting the particle concentration of the carbon material and the integrated value of the particle areas of the carbon material so as to be within specific ranges.

When the particle concentration of a carbon material and the integrated value of the particle areas of the carbon material are equal to or more than the above lower limits, contact points with an active material can be sufficiently ensured and a good electron conduction path can be formed, when the carbon material is used in the electrode of a power storage device. Further, when the particle concentration of a carbon material and the integrated value of the particle areas of the carbon material are equal to or less than the above upper limits, the carbon material rarely obstructs the movement of ions such as lithium ions.

Therefore, the carbon material of the present invention, when used in the electrode of a power storage device, can effectively enhance the capacity of a power storage device, and battery characteristics such as rate characteristics and cycle characteristics.

In the present invention, the BET specific surface area of the carbon material is preferably 1 m²/g or more and 25 m²/g or less, more preferably 5 m²/g or more and less than 25 m²/g, and further preferably 8 m²/g or more and 20 m²/g or less. In this case, the conductivity can be further enhanced.

In the present invention, the particle concentration of an N-methyl-2-pyrrolidone solution containing 20 ppm of the carbon material is preferably 3,000 particles/μL or more, and preferably 50,000 particles/μL or less. It is more preferable that the particle concentration is 5,000 particles/μL or more and 30,000 particles/μL or less. When the particle concentration of the carbon material is equal to or more than the above lower limit, contact points with an active material can be more sufficiently ensured and a better electron conduction path can be formed, when the carbon material is used in the electrode of a power storage device. When the particle concentration of the carbon material is equal to or less than the above upper limit, the carbon rarely obstructs the movement of ions such as lithium ions.

In the present invention, the integrated value of the particle areas of the carbon material is preferably 1,000 mm²/mg or more and preferably 10,000 mm²/mg or less. It is more preferable that the integrated value is 2,000 mm²/mg or more and 8,000 mm²/mg or less. When the integrated value of the particle areas of the carbon material is equal to or more than the above lower limit, contact points with an active material can be more sufficiently ensured and a better electron conduction path can be formed, when the carbon material is used in the electrode of a power storage device. When the integrated value of the particle areas of the carbon material is equal to or less than the above upper limit, the carbon material rarely obstructs the movement of ions such as lithium ions.

It is preferable that the carbon material of the present invention, when subjected to a differential thermal analysis at a heating rate of 10° C./min, has an exothermic peak having a peak temperature of 700° C. or lower. The exothermic peak having a peak temperature of 700° C. or lower is a peak caused by oxidative decomposition of the carbon material. When the carbon material has such an exothermic peak, the integrated value of the particle areas of the carbon material can be further increased. Therefore, contact points with an active material can be more sufficiently ensured, and a better electron conduction path can be formed.

The differential thermal analysis (DTA) can be performed within a range of, for example, 30° C. to 1000° C. by using a differential thermal analyzer. As the differential thermal analyzer, for example, a differential thermal thermogravimetric simultaneous measuring device (manufactured by Seiko Instruments Inc., product number “TG/DTA6300”) can be used.

Further, it is preferable in the present invention that the carbon material, when subjected to a differential thermal analysis at a heating rate of 10° C./min, has a first exothermic peak having a peak temperature of 500° C. or higher and 700° C. or lower and a second exothermic peak having a peak temperature of 400° C. or higher and 500° C. or lower. In this case, the first exothermic peak is an exothermic peak caused by oxidative decomposition of the carbon material. The second exothermic peak is an exothermic peak caused by oxidative decomposition of a synthetic resin or a carbide of the synthetic resin. When the carbon material has such a second exothermic peak, the dispersibility in an electrode forming slurry can be further enhanced, and the addition amount of a binder resin can be further reduced.

In the present invention, the content of a component derived from the second exothermic peak is preferably 0.1% by weight or more and 20% by weight or less, and more preferably 10% by weight or less. When the content of the component derived from the second exothermic peak is equal to or more than the above lower limit, the addition amount of a binder resin at the time of producing the electrode can be further reduced. Further, when the content of the component derived from the second exothermic peak is equal to or less than the above upper limit, the conductivity of the carbon material can be further enhanced. Note that in TG thermogravimetric measurement and when it is assumed that the weight at 300° C. is 100% and the weight at 800° C. is 0%, the content of the component derived from the second exothermic peak means a weight loss rate at the temperature at the lowest point between the first exothermic peak and the second exothermic peak in DTA differential thermal analysis.

As described above, the carbon material of the present invention may contain the component derived from the second exothermic peak, that is, contain a synthetic resin or a carbide of the synthetic resin. In this case, it is preferable that the synthetic resin is grafted to or adsorbed on the carbon material.

As the synthetic resin, it is preferable to use a synthetic resin containing, for example, an oxygen atom. As the synthetic resin, for example, (meth)acrylic resin, vinyl acetate resin, polypropylene glycol resin, polyethylene glycol resin, polyglycidyl methacrylate resin, polyvinyl butyral resin, polystyrene resin, etc., can be used. Among them, it is preferable to use (meth)acrylic resin, vinyl acetate resin, polypropylene glycol resin, polyethylene glycol resin, etc., as the synthetic resin. The (meth)acrylic resin means a methacrylic resin or an acrylic resin. These synthetic resins may be used alone or in combination of two or more.

In the present invention, the powder resistance of the carbon material is preferably 1×10⁻¹ Ω·cm or less, more preferably 1×10⁻² Ω·cm or less, and further preferably 5×10⁻³ Ω·cm or less. The powder resistance of the carbon material can be measured by, for example, a powder resistivity measuring unit (MCP-D51) using a four-probe ring electrode (manufactured by Mitsubishi Chemical Analytech Co., Ltd., product name “Loresta-CX Low Resistivity Meter”).

The carbon material of the present invention can be obtained by, for example, firing a mixture of graphite and a resin. As described above, by firing a mixture of graphite and resin, the thermally decomposed resin is grafted to a terminal functional group of the graphite. Then, the carbonization of a part or all of the resin reduces the crystallinity of the ends of the graphite. This lowers the oxidative decomposition temperature of the graphite.

In the present invention, it is preferable to use layered graphite as the raw material graphite. Since layered graphite has a plate-like shape and easily forms a conductive path, the conductivity can be further enhanced. In this case, it is preferable that the layered graphite is not expanded graphite that is likely to have a larger interlayer distance between graphene layers than normal graphite. In that case, a carbon material having a smaller specific surface area can be obtained. In addition, the conductivity can be further enhanced.

The thickness of the raw material graphite is preferably 500 nm or less, and more preferably 200 nm or less. In this case, it is preferable that the thickness of the raw material graphite is reduced by physical processing. Thereby, the thickness of the graphite can be reduced without destroying the graphene layered structure, and the integrated value of the particle areas of the obtained carbon material can be increased. The lower limit of the thickness of the raw material graphite can be set to, for example, 10 nm. The thickness of the raw material graphite can be determined by using a scanning electron microscope (SEM), a transmission electron microscope (TEM), etc.

The heating temperature at the time of firing the resin is not particularly limited depending on the type of the resin, but can be set to, for example, 300° C. or higher and 800° C. or lower. The heating time can be set to, for example, 10 minutes or more and 4 hours or less. The heating may be performed in the air or in the atmosphere of an inert gas such as nitrogen gas. However, from the viewpoint of further enhancing the conductivity of the carbon material, it is desirable to perform the heating in the atmosphere of an inert gas such as nitrogen gas.

The resin is not particularly limited, but is preferably a polymer of a radically polymerizable monomer. In this case, it may be a homopolymer of one type of a radically polymerizable monomer or a copolymer of a plurality of types of radically polymerizable monomers. The radically polymerizable monomer is not particularly limited as long as it is a monomer having a radically polymerizable functional group.

Examples of the radically polymerizable monomer include, for example: styrene; α-substituted acrylate esters such as methyl α-ethyl acrylate, methyl α-benzyl acrylate, methyl α-[2,2-bis(carbomethoxy)ethyl]acrylate, dibutyl itaconate, dimethyl itaconate, dicyclohexyl itaconate, α-methylene-δ-valerolactone, α-methylstyrene, and α-acetoxystyrene; vinyl monomers having a glycidyl group or a hydroxyl group such as glycidyl methacrylate, 3,4-epoxycyclohexylmethyl methacrylate, hydroxyethyl methacrylate, hydroxyethyl acrylate, hydroxypropyl acrylate, and 4-hydroxybutyl methacrylate; vinyl monomers having an amino group such as allylamine, diethylaminoethyl (meth)acrylate, and dimethylaminoethyl (meth)acrylate; monomers having a carboxyl group such as methacrylic acid, maleic anhydride, maleic acid, itaconic acid, acrylic acid, crotonic acid, 2-acryloyloxyethyl succinate, 2-methacryloyloxyethyl succinate, and 2-methacryloyloxyethyl phthalic acid; monomers having a phosphate group such as Phosmer (registered trademark) M, Phosmer (registered trademark) CL, Phosmer (registered trademark) PE, Phosmer (registered trademark) MH, and Phosmer (registered trademark) PP that are manufactured by Uni-Chemical Co, Ltd.; monomers having an alkoxysilyl group such as vinyltrimethoxysilane and 3-methacryloxypropyltrimethoxysilane; (meth)acrylate-based monomers having an alkyl group, a benzyl group, or the like; and the like.

Examples of the resin to be used include (meth)acrylic resin, vinyl acetate resin, polypropylene glycol resin, polyethylene glycol resin, polyglycidyl methacrylate resin, polyvinyl butyral resin, polystyrene rein, etc.

Among them, it is more preferable to use (meth)acrylic resin, vinyl acetate resin, polypropylene glycol resin, polyethylene glycol resin, etc., as the resin.

When a composite with the later-described positive electrode active material is produced, the amount of the resin may be reduced or the resin may be removed after the composite with the positive electrode active material is produced.

As a method for reducing the amount of the resin or removing the resin, method for performing a heat treatment at a temperature equal to or higher than the decomposition temperature of the resin and lower than the decomposition temperature of the positive electrode active material is preferable. This heat treatment may be performed in any of the air, an inert gas atmosphere, a low oxygen atmosphere, or a vacuum.

The carbon material of the present invention may be partially exfoliated graphite having a structure in which graphite is partially exfoliated.

In an example of the structure in which “graphite is partially exfoliated,” the graphene layer, in the graphene laminate, is open from the edge to a position located sort of inside, that is, a part of the graphite is exfoliated at the edge, while in a portion near to the center, the graphite layer is laminated in the same way as the original graphite or primary exfoliated graphite. Therefore, the portion where the graphite is partially exfoliated at the edge is connected to the portion near to the center. Additionally, the partially exfoliated graphite may include graphite in which the graphite at the edge is exfoliated.

In the partially exfoliated graphite, the graphite layer is laminated in the portion near to the center in the same way as the original graphite or primary exfoliated graphite. Therefore, it has a higher graphitization degree than the conventional graphene oxide and carbon black, and is excellent in conductivity. Further, it has a structure in which graphite is partially exfoliated, and hence it has a large specific surface area. Therefore, the area of the portion in contact with the active material can be increased. Therefore, when used in the electrode of a power storage device such as a secondary battery, the partially exfoliated graphite can further reduce the resistance of the power storage device.

The partially exfoliated graphite can be produced by, for example, the same method as the method for producing an exfoliated graphite/resin composite material described in WO 2014/034156 A. Specifically, the partially exfoliated graphite can be obtained by preparing a composition in which graphite and a resin are mixed and thermally decomposing the resin contained in the composition. The present invention further reduces the resistance of a power storage device by setting the BET specific surface area, the particle concentration, and the integrated value of the particle areas so as to be within specific ranges Note that when the resin is thermally decomposed, the resin may be thermally decomposed while a part of the resin is allowed to remain, or the resin may be completely thermally decomposed.

### [Electrode for Power Storage Device]

The carbon material of the present invention can be used in an electrode for a power storage device, that is used in at least one of the positive electrode and the negative electrode of a power storage device. In particular, when the carbon material is used in a conductive aid in the positive electrode of a non-aqueous electrolyte secondary battery, particularly a lithium ion secondary battery, the carbon material can improve the capacity and further improve the cycle characteristics and rate characteristics. Therefore, the carbon material can be suitably used in a conductive aid in the positive electrode. Further, in this case, the conductivity of the positive electrode can be further enhanced by using the carbon material of the present invention, and hence the content of the conductive aid in the positive electrode can be reduced. Therefore, the content of the positive electrode active material can be further increased, and the energy density of a power storage device can be further increased. The positive electrode may have general positive electrode configuration and composition, and may be produced by a general production method, or may be produced by using a composite of the positive electrode active material and the carbon material of the present invention.

When the electrode for a power storage device is a negative electrode, for example, natural graphite, artificial graphite, hard carbon, a metal oxide, lithium titanate, or a silicon-based active material can be used as a negative electrode active material.

The content of the carbon material in 100% by weight of the electrode for a power storage device is preferably 0.4% by weight or more and more preferably 0.8% by weight or more, and preferably 15% by weight or less and more preferably 10% by weight or less. When the content of the carbon material is within the above range, the content of the active material can be further increased, and the energy density of the power storage device can be further increased.

When the carbon material of the present invention is assumed to be a first carbon material (unless otherwise noted, simply referred to as a carbon material) in the electrode for a power storage device of the present invention, a second carbon material that is different from the first carbon material may be further contained.

The second carbon material is not particularly limited, and examples thereof include graphene, artificial graphite, a granular graphite compound, a fibrous graphite compound, carbon black, and activated carbon.

Hereinafter, a positive electrode for a secondary battery, as an example of the electrode for a power storage device of the present invention, will be described. Note that the same materials (excluding the positive electrode active material) can also be used when the electrode for a power storage device is a negative electrode for secondary battery.

The positive electrode active material to be used in the electrode for a power storage device of the present invention may be nobler than the battery reaction potential of a negative electrode active material. At that time, ions of group 1 or group 2 elements may be involved in the battery reaction. Examples of such ions include, for example, H ions, Li ions, Na ions, K ions, Mg ions, Ca ions, and Al ions. Hereinafter, details of a system in which Li ions are involved in the battery reaction will be described as an example.

Examples of the positive electrode active material include, for example, a lithium metal oxide, lithium sulfide, and sulfur.

Examples of the lithium metal oxide include those having a spinel structure, a layered rock salt structure, and an olivine structure, and a mixture thereof.

Examples of the lithium metal oxide having a spinel structure include lithium manganate, etc.

Examples of the lithium metal oxide having a layered rock salt structure include a lithium cobalt oxide, a lithium nickel oxide, a ternary system, etc.

Examples of the lithium metal oxide having an olivine structure include lithium iron phosphate, lithium manganese iron phosphate, lithium manganese phosphate, etc.

The positive electrode active material may contain a so-called doping element. The positive electrode active materials may be used alone or in combination of two or more.

The positive electrode may be formed only of the positive electrode active material and the carbon material, but it is preferable that a binder resin is contained from the viewpoint of forming the positive electrode more easily.

The binder resin is not particularly limited, and for example, polyvinylidene fluoride (PVdF), polytetrafluoroethylene (PTFE), styrene-butadiene rubber, polyimide, or derivatives thereof can be used. These may be used alone or in combination of two or more.

From the viewpoint of producing the positive electrode more easily, it is preferable that the binder resin is dissolved or dispersed in a non-aqueous solvent or water.

The non-aqueous solvent is not particularly limited, and examples thereof include, for example, N-methyl-2-pyrrolidone (NMP), dimethylformamide, dimethylacetamide, methyl ethyl ketone, methyl acetate, ethyl acetate, tetrahydrofuran, etc. A dispersant or a thickener may be added to them.

The content of the binder in 100% by weight of the electrode for a power storage device is preferably 0.1% by weight or more and 15% by weight or less, and more preferably 0.3% by weight or more and 10% by weight or less. When the amount of the binder resin is within the above range, the adhesiveness between the positive electrode active material and the carbon material can be maintained, and the adhesiveness with a current collector can be further enhanced.

Examples of a method for producing the positive electrode include, for example, a method for producing the positive electrode by forming a mixture of the positive electrode active material, the carbon material, and the binder resin on the current collector.

From the viewpoint of producing the positive electrode more easily, it is preferable to produce it as follows. First, a slurry is produced by adding a binder solution or a dispersion liquid to the positive electrode active material and the carbon material and mixing them. Next, the produced slurry is coated onto the current collector, and finally the solvent is removed, thereby producing the positive electrode.

As the method for producing the above slurry, an existing method can be used. For example, a method for mixing them by using a mixer or the like can be mentioned. The mixer to be used for the mixing is not particularly limited, and examples thereof include a planetary mixer, a disper, a thin film swirling mixer, a jet mixer, a self-rotating mixer, etc.

From the viewpoint of performing the coating more easily, the solid content concentration of the slurry is preferably 30% by weight or more and 95% by weight or less. From the viewpoint of further increasing storage stability, the solid content concentration of the slurry is more preferably 35% by weight or more and 90% by weight or less, and further preferably 40% by weight or more and 85% by weight or less.

The solid content concentration can be controlled by a diluting solvent. As the diluting solvent, it is preferable to use a solvent of the same type as the binder solution or the dispersion liquid. Other solvents may be used as long as they have solvent compatibility.

It is preferable that the current collector to be used in the positive electrode is made of aluminum or an alloy containing aluminum. The aluminum is not particularly limited because it is stable in a positive electrode reaction atmosphere, but high-purity aluminum, represented by JIS standard 1030, 1050, 1085, 1N90, 1N99, or the like, is preferable.

The thickness of the current collector is not particularly limited, but is preferably 10 μm or more and 100 μm or less. If the thickness of the current collector is less than 10 μm, handling may be difficult from the viewpoint of production. On the other hand, if the thickness of the current collector is more than 100 μm, it may be disadvantageous from an economic point of view.

Note that the current collector may be one in which the surface of a metal (copper, SUS, nickel, titanium, or an alloy thereof) other than aluminum is covered with aluminum.

A method for coating the slurry to the current collector is not particularly limited, and examples of the method include, for example, a method for removing, after the slurry is coated by a doctor blade, a die coater, a comma coater, etc., the solvent; a method for removing, after the slurry is coated by spraying, the solvent; a method for removing, after the slurry is coated by screen printing, the solvent; and the like.

It is preferable that the method for removing the solvent adopts drying using a blower oven or a vacuum oven, because it is easier. Examples of the atmosphere in which the solvent is removed include an air atmosphere, an inert gas atmosphere, a vacuum state, etc. The temperature at which the solvent is removed is not particularly limited, but is preferably 60° C. or higher and 250° C. or lower. If the temperature at which the solvent is removed is lower than 60° C., it may take time to remove the solvent. On the other hand, if the temperature at which the solvent is removed is higher than 250° C., the binder resin may deteriorate.

The positive electrode may be compressed to desired thickness and density. The compression is not particularly limited, and can be performed by using, for example, a roll press, a hydraulic press, etc.

The thickness of the positive electrode after being compressed is not particularly limited, but is preferably 10 μm or more and 1000 μm or less. If the thickness is less than 10 μm, it may be difficult to obtain a desired capacity. On the other hand, if the thickness is more than 1000 μm, it may be difficult to obtain a desired power density.

The density of the positive electrode is not particularly limited, but is preferably 1.0 g/cm³ or more and 5.0 g/cm³ or less. If the density is less than 1.0 g/cm³, the contact between the positive electrode active material and the carbon material becomes insufficient, and the electron conductivity may decrease. On the other hand, if the density is more than 5.0 g/cm³, the later-described electrolytic solution is less likely to penetrate into the positive electrode, and the lithium conductivity may decrease.

The electric capacity per 1 cm² of the positive electrode is preferably 0.5 mAh or more and 10.0 mAh or less. If the electric capacity is less than 0.5 mAh, the size of a battery having a desired capacity may increase. On the other hand, if the electric capacity is more than 10.0 mAh, it may be difficult to obtain a desired power density. The electric capacity per 1 cm² of the positive electrode can be calculated by producing the positive electrode, producing a half-cell with the counter electrode made of lithium metal, and measuring charge/discharge characteristics.

The electric capacity per 1 cm² of the positive electrode is not particularly limited, and can be controlled by the weight of the positive electrode formed per unit area of the current collector. For example, it can be controlled by a coating thickness when the slurry is coated.

Alternatively, the positive electrode may be produced by using a composite of the positive electrode active material and the carbon material, that is, an active material-carbon material composite.

In the active material-carbon material composite, the weight ratio of the carbon material to the positive electrode active material is preferably 0.2% by weight or more and 10.0% by weight or less, based on 100% by weight of the total weight of the positive electrode active material and the carbon material. From the viewpoint of further improving rate characteristics, the weight of the carbon material is more preferably 0.3% by weight or more and 8.0% by weight or less. From the viewpoint of further improving cycle characteristics, the weight of the carbon material is further preferably 0.5% by weight or more and 7.0% by weight or less.

### [Power Storage Device]

A power storage device of the present invention includes the above-described electrode for a power storage device of the present invention. Therefore, the capacity of the power storage device and the battery characteristics such as rate characteristics and cycle characteristics can be improved.

As described above, the power storage device of the present invention is not particularly limited, and examples thereof include a non-aqueous electrolyte primary battery, an aqueous electrolyte primary battery, a non-aqueous electrolyte secondary battery, an aqueous electrolyte secondary battery, an all-solid electrolyte primary battery, an all-solid electrolyte secondary battery, a capacitor, an electric double layer capacitor, a lithium ion capacitor, etc.

The secondary battery as an example of the power storage device of the present invention may be any one that uses a compound that promotes insertion and elimination reactions of alkali metal ions or alkaline earth metal ions. Examples of the alkali metal ion include a lithium ion, a sodium ion, and a potassium ion. Examples of the alkaline earth metal ion include a calcium ion and a magnesium ion. In particular, the present invention has a great effect on the positive electrodes of non-aqueous electrolyte secondary batteries. Among them, the present invention can be suitably applied to those using lithium ions. Hereinafter, a non-aqueous electrolyte secondary battery using lithium ions (hereinafter, lithium ion secondary battery) will be described as an example.

The positive electrode and the negative electrode of the non-aqueous electrolyte secondary battery may have a form in which the same electrodes are formed on both surfaces of the current collector. Alternatively, they may have a form in which the positive electrode is formed on one surface of the current collector and the negative electrode is formed on the other surface, that is, they may be bipolar electrodes.

The non-aqueous electrolyte secondary battery may have a wound type or laminated type of a separator disposed between the positive electrode and the negative electrode. The positive electrode, the negative electrode, and the separator contain a non-aqueous electrolyte responsible for lithium ion conduction.

The non-aqueous electrolyte secondary battery may be covered with a laminate film after the laminated body is wound or a plurality of the laminated bodies are laminated, or covered with a metal can having a rectangular shape, elliptical shape, cylindrical shape, coin shape, button shape, or sheet shape. The cover may be provided with a mechanism for releasing the generated gas. The number of the laminated layers of the laminated body is not particularly limited, and the laminated bodies can be laminated until a desired voltage value and battery capacity are exhibited.

The above non-aqueous electrolyte secondary battery can be built into an assembled battery in which the non-aqueous electrolyte secondary batteries are appropriately connected in series or in parallel according to a desired size, capacity, or voltage. In the above assembled battery, it is preferable that a control circuit is attached to the assembled battery in order to confirm the charge state of each battery and improve safety.

The separator to be used in the non-aqueous electrolyte secondary battery is not particularly limited as long as: it is disposed between the positive electrode and the negative electrode; it is insulative; and it has a structure capable of containing the later-described non-aqueous electrolyte. Examples of the material of the separator include, for example: nylon, cellulose, polysulfone, polyethylene, polypropylene, polybutene, polyacrylonitrile, polyimide, polyamide, polyethylene, and terephthalate; a woven fabric, a non-woven fabric, and a microporous membrane, each of which is formed of a composite of two or more of the above materials; and the like.

The non-aqueous electrolyte to be used in the non-aqueous electrolyte secondary battery is not particularly limited, and for example, an electrolytic solution in which a solute is dissolved in a non-aqueous solvent can be used. Alternatively, a gel electrolyte in which a polymer is impregnated with an electrolytic solution in which a solute is dissolved in a non-aqueous solvent, a polymer solid electrolyte such as polyethylene oxide or polypropylene oxide, or an inorganic solid electrolyte such as sulfide glass or oxynitride, may be used.

It is preferable that the non-aqueous solvent contains at least one of a cyclic aprotic solvent and a chain aprotic solvent, because it can dissolve the later-described solute more easily.

Examples of the cyclic aprotic solvent include cyclic carbonate, cyclic ester, cyclic sulfone, cyclic ether, etc.

Examples of the chain aprotic solvent include chain carbonate, chain carboxylic acid ester, chain ether, etc.

Alternatively, a solvent generally used as a solvent for a non-aqueous electrolyte, such as acetonitrile, may be used. More specifically, dimethyl carbonate, methyl ethyl carbonate, dimethyl carbonate, dipropyl carbonate, methyl propyl carbonate, ethylene carbonate, propylene carbonate, butylene carbonate, γ-butyl lactone, 1,2-dimethoxyethane, sulfolane, dioxolane, methyl propionate, etc., can be used. These solvents may be used alone or in combination of two or more. However, from the viewpoints of dissolving the later-described solute more easily and further enhancing the conductivity of a lithium ion, it is preferable to use a solvent in which two or more types of the solvents are mixed.

The solute is not particularly limited, but it is preferable to use LiClO₄, LiBF₄, LiPF₆, LiAsF₆, LiCF₃SO₃, LiBOB (Lithium Bis(Oxalato)Borate), or LiN(SO₂CF₃)₂. In this case, the solute can be more easily dissolved in the non-aqueous solvent.

The concentration of the solute contained in the electrolytic solution is preferably 0.5 mol/L or more and 2.0 mol/L or less. If the concentration of the solute is less than 0.5 mol/L, a desired lithium ion conductivity may not be exhibited. On the other hand, if the concentration of the solute is more than 2.0 mol/L, the solute may not be dissolved any more.

Additionally, the non-aqueous electrolyte may further contain additives such as a flame retardant and a stabilizer.

Next, the present invention will be clarified by giving specific examples of the present invention and comparative examples. Note that the present invention is not limited to the following examples.

### EXAMPLE 1

With 1 kg of pure water, 0.9 g of carboxymethyl cellulose sodium salt (manufactured by Aldrich, average molecular weight 250,000) and 30 g of layered graphite (manufactured by Nippon Graphite Industry Co., Ltd., product name “UP-5α”) were mixed, and they were dispersed and mixed at 10,000 rpm for 30 minutes by using a homomixer (manufactured by PRIMIX Corp., “Homomixer MARK II”). Subsequently, 150 g of polyethylene glycol (manufactured by Sanyo Chemical Industry, LTD., PEG600) was added as the synthetic resin, and they were mixed at 10,000 rpm for another 30 minutes to obtain a graphite dispersion solution.

The obtained graphite dispersion solution was dried in a hot air oven at 150° C. for 3 hours to obtain. 120 g of a graphite composite composition.

Next, the graphite composite composition was heated under a nitrogen atmosphere inert condition at 370° C. for 1 hour, and then it was subjected to heat processing at 420° C. for 1.5 hours in an atmosphere of an oxygen concentration of 5% and a nitrogen concentration of 95%, thereby obtaining a carbon compound 1 as the carbon material.

### EXAMPLE 2

A graphite compound 2 as the carbon material was obtained in the same way as in Example 1, except that the compounding amount of the polyethylene glycol (PEG600) was set to 60 g.

### EXAMPLE 3

A graphite compound 3 as the carbon material was obtained in the same way as in Example 1, except that instead of the layered graphite (manufactured by Nippon Graphite Industry Co., Ltd., product name “DP-5α”), layered graphite (manufactured by Fuji Kokuen K. K., product name “MAG-4J”) was used.

### EXAMPLE 4

A graphite compound 4 as the carbon material was obtained in the same way as in Example 1, except that a glycidoxymethacrylate polymer (GMA resin) was used as the synthetic resin.

### EXAMPLE 5

A graphite compound 5 as the carbon material was obtained in the same way as in Example 1, except that a vinyl acetate resin was used as the synthetic resin.

### EXAMPLE 6

A graphite compound 6 as the carbon material was obtained in the same way as in Example 1, except that polypropylene glycol (PPG600) was used as the synthetic resin.

### COMPARATIVE EXAMPLE 1

As the carbon material, layered graphite (manufactured by Fuji Kokuen K. K., product name “MAG-7J”) was used as it was.

### COMPARATIVE EXAMPLE 2

A graphite compound 7 as the carbon material was obtained in the same way as in Example 1, except that instead of the layered graphite (manufactured by Nippon Graphite Industry Co., Ltd., product name “UP-5α”), layered graphite (manufactured by Fuji Kokuen K. K., “MAG-7J”) was used.

### COMPARATIVE EXAMPLE 3

A graphite compound 8 as the carbon material was obtained in the same way as in Example 1, except that instead of the layered graphite (manufactured by Nippon Graphite Industry Co., Ltd., product name “UP-5α”), layered graphite (manufactured by Fuji Kokuen K. K., SP-10) was used.

### COMPARATIVE EXAMPLE 4

As the carbon material, acetylene black (AB, manufactured by Denka Co., Ltd., product name “Denka Black Li-400”) was used as it was.

### COMPARATIVE EXAMPLE 5

As the carbon material, graphene (manufactured by Raymor Industries Inc. product name “Graphene Nanoplatelets (GNP)”) was used as it was.

### COMPARATIVE EXAMPLE 6

As the carbon material, graphene (manufactured by XG Sciences, Inc., product name “R25”) was used as it was.

### COMPARATIVE EXAMPLE 7

A graphite compound 9 as the carbon material was obtained in the same way as in Comparative Example 2, except that the compounding amount of the polyethylene glycol (PEG600) was set to 90 g and the firing conditions in an atmosphere of an oxygen concentration of 5% and a nitrogen concentration of 95% were set to 420° C. and 0.5 hours.

### COMPARATIVE EXAMPLE 8

A graphite compound 10 as the carbon material was obtained in the same way as in the Comparative Example 3, except that the compounding amount of the polyethylene glycol (PEG600) was set to 90 g and the firing conditions in an atmosphere of an oxygen concentration of 5% and nitrogen concentration of 95% were set to 420° C. and 0.5 hours.

### [Evaluation of Carbon Materials]

### (BET Specific Surface Area)

A BET specific surface area was measured by using a specific surface area measuring device (manufactured by Shimadzu Corporation, product number “ASAP-2000”, nitrogen gas).

### (Thermal Analysis)

Thermal analysis was performed by heating from 30° C. to 1000° C. under conditions in which a heating rate was 10° C./min and an air flow rate was 2 mL/min and by using a differential thermal thermogravimetric simultaneous measuring device (Seiko Instruments Inc., product number “TG/DTA6300”). Thereby, the temperature of the first exothermic peak caused by oxidative decomposition of the carbon material was determined. Also, the content of the component of the second exothermic peak caused by oxidative decomposition of the synthetic resin was determined.

### (Particle Concentration and Particle Area)

The particle concentration of the carbon material was obtained by capturing a still image of the particles flowing in a flow cell with the use of a flow-type particle image analyzer (manufactured by Sysmex Corp., product number “FPIA-3000S”) using an N-methyl-2-pyrrolidone solution containing 20 ppm of the carbon material, and then by measuring a particle concentration. The particle area of the carbon material was calculated by the following procedure. First, the particle area was calculated from an equivalent circle diameter that was the diameter of a circle having the same area as the projected area of a particle. Then, a product of the particle area and the number of the particles in each particle diameter (equivalent circle diameter) was calculated, and the products were added up for all particle diameters, thereby obtaining the integrated value. The particle concentration and the equivalent circle diameter were analyzed by using the image analysis software attached to a flow-type particle image analyzer (manufactured by Sysmex Corp., product number “FPIA-3000S”, Version 00-17).

### (Powder Resistance)

Powder resistance was measured by a powder resistivity measuring unit (MCP-PD51) using a four-probe ring electrode (manufactured by Mitsubishi Chemical Analytech Co., Ltd., product name “Loresta-GX low resistivity meter”).

### [Evaluation of Battery Characteristics]

Nonaqueous electrolyte secondary batteries were produced by: using the carbon materials obtained in Examples 1 to 6 and Comparative Examples 1 to 8 and in the following way, and then battery characteristics were evaluated.

### (Production of Positive Electrode)

Specifically, to each of the carbon materials obtained Examples 1 to 6 and Comparative Examples 1 to 8, N-methyl-2-pyrrolidone was added as a dispersion medium, and a dispersion liquid was prepared such that the content of the carbon material was 0.01% by weight with respect to the dispersion medium. The prepared dispersion liquid was treated with an ultrasonic cleaner (manufactured by AS ONE Corp.) for 5 hours to prepare a carbon material dispersion liquid.

Next, LiCo_{1/3}Ni_{1/3}Mn_{1/3}O₂ as the positive electrode active material was produced by the method described in Non-Patent Document (Journal of Power Sources, Vol. 146, pp. 636-639 (2005)).

That is, first, lithium hydroxide and a three-element hydroxide having a molar ratio of cobalt, nickel, and manganese of 1:1:1 were mixed at a ratio of 1:1 to obtain a mixture. Next, this mixture was heated at 1000° C. in an air atmosphere, thereby producing a positive electrode active material.

Next, to 92 parts by weight of the positive electrode active material, 4 parts by weight of the carbon material dispersion liquid produced as described above were added, and further a binder (PVdF, solid content concentration 12% by weight, NMP solution) was mixed such that the solid content of the binder was 4 parts by weight, thereby producing a positive electrode slurry. Next, this positive electrode slurry was coated to an aluminum foil (20 μm), and then the solvent was removed by a blower oven under the conditions of 120° C. and 1 hour. Then, it was vacuum-dried under the conditions of 120° C. and 12 hours. Similarly, the positive electrode slurry was also coated to the back surface of the aluminum foil and dried.

Finally, it was pressed by a roll press machine to produce a positive electrode (double-sided coating) having an electrode density of 3.3 g·cc⁻¹. Note that the electrode density was calculated from the weight and thickness of the electrode per unit area. The capacity of the positive electrode was calculated from the electrode weight per unit area and the theoretical capacity (150 mAh/g) of the positive electrode active material. As a result, the capacity (both sides) of the positive electrode was 5.0 mAh/cm².

### (Production of Non-Aqueous Electrolyte Secondary Battery)

First, the produced positive electrode (electrode portion 40 mm×50 mm), negative electrode (metal Li foil, electrode portion: 45 mm×55 mm), and separator (polyolefin microporous membrane, 25 μm, 50 mm×60 mm) were laminated in the order of negative electrode/separator/positive electrode/separator/negative electrode such that the capacity of the positive electrode was 500 mAh (5 positive electrodes, 6 negative electrodes). Next, an aluminum tab and a nickel-plated copper tab were vibration-welded to the positive electrode and the negative electrode at both ends, respectively. Then, it was put in a bag-shaped aluminum laminate sheet, and the three sides were heat-welded to produce a non-aqueous electrolyte secondary battery before the encapsulation of an electrolytic solution. Further, the non-aqueous electrolyte secondary battery before the encapsulation of an electrolytic solution was vacuum-dried under the conditions of 60° C. and 3 hours, and then 20 g of a non-aqueous electrolyte (ethylene carbonate/dimethyl carbonate: ½ volume %, LiPF₆:1 mol/L) was put. Then, a non-aqueous electrolyte secondary battery was produced by sealing under reduced pressure. The above steps were performed in an atmosphere (dry box) having a dew point of −40° C. or lower.

### (Evaluation of Initial Discharge Capacity, Cycle Characteristics, Rate Characteristics)

The produced non-aqueous electrolyte secondary battery was charged/discharged from 2.5 V to 4.25 V, and the value of the discharge capacity at 0.2 C was taken as an initial discharge capacity. Then, rate characteristics (2 C/0.2 C) were calculated from the value of the discharge capacity at 2 C. Further, charging/discharging at 0.5 C was repeated 30 times, and the ratio to the initial discharge capacity was taken as cycle characteristics (discharge capacity after repeating 30 times/initial discharge capacity).

The results are shown in Table 1 below.

TABLE 1

| | | | | | | | Comparative |
|---|---|---|---|---|---|---|---|
| | Example 1 | Example 2 | Example 3 | Example 4 | Example 5 | Example 6 | Example 1 |
| Graphite compound | Graphite | Graphite | Graphite | Graphite | Graphite | Graphite | |
| | compound 1 | compound 2 | compound 3 | compound 4 | compound 5 | compound 6 | |
| Graphite | UP-5α | UP-5α | MAG-4J | UP-5α | UP-5α | U-5α | MAG-7J |
| Synthetic resin | PEG600 | PEG600 | PEG600 | GMA | Vinyl | PPG600 | — |
| | | | | resin | acetate | | |
| | | | | | resin | | |
| Graphite weight (g) | 30 | 30 | 30 | 30 | 30 | 30 | — |
| Synthetic resin weight (g) | 150 | 60 | 150 | 150 | 150 | 150 | — |
| Inert firing conditions (° C./hour) | 370° C./ | 370° C./ | 370° C./ | 370° C./ | 370° C./ | 370° C./ | — |
| | 1 hour | 1 hour | 1 hour | 1 hour | 1 hour | 1 hour | |
| Firing conditions (° C./hours) in | 420° C./ | 420° C./ | 420° C./ | 420° C./ | 420° C./ | 420° C./ | — |
| oxygen concentration 5% and | 1.5 hours | 1.5 hours | 1.5 hours | 1.5 hours | 1.5 hours | 1.5 hours | |
| nitrogen concentration of 95% | | | | | | | |
| BET specific surface area (m²/g) | 23 | 15 | 12 | 21 | 20 | 20 | 7.3 |
| First exothermic peak (° C.) | 637 | 620 | 627 | 652 | 649 | 661 | 747 |
| Content of component derived | 4.7 | 0 | 2.5 | 64 | 9.2 | 4.4 | — |
| from second exothermic | | | | | | | |
| peak (% by weight) | | | | | | | |
| Particle concentration (particles/μL) | 10,470 | 8,950 | 28,630 | 9,520 | 8,890 | 9,220 | 1.640 |
| Integrated value of particle areas | 2,677 | 3,510 | 5,570 | 2,520 | 2,330 | 2,540 | 770 |
| (mm²/mg) | | | | | | | |
| Powder resistance (Ω · cm) | 3 × 10⁻³ | 3 × 10⁻³ | 3 × 10⁻³ | 4 × 10⁻³ | 4 × 10⁻³ | 3 × 10⁻³ | 1 · 10⁻³ |
| Initial discharge capacity (mAh/g) | 185.1 | 184 | 183.2 | 180.1 | 181.0 | 185.3 | 154.3 |
| Rate characteristics (2 C/0.2 C) | 32.5 | 29.7 | 25.3 | 24.2 | 23.9 | 29.6 | 0.1 |
| Cycle characteristics (30th/1st) | 89.4 | 82.8 | 82.0 | 80.2 | 81.8 | 88.4 | — |

| | Comparative | Comparative | Comparative | Comparative | Comparative | Comparative | Comparative |
|---|---|---|---|---|---|---|---|
| | Example 2 | Example 3 | Example 4 | Example 5 | Example 6 | Example 7 | Example 8 |
| Graphite compound | Graphite | Graphite | | | | Graphite | Graphite |
| | compound 7 | compound 8 | | | | compound 9 | compound 10 |
| Graphite | MAG-7J | SP-10 | Li 400 | GNP | R25 | MAG-7J | SP-10 |
| Synthetic resin | PEG600 | PEG600 | — | — | — | PEG600 | PEG600 |
| Graphite weight (g) | 30 | 30 | — | — | — | 30 | 30 |
| Synthetic resin weight (g) | 150 | 150 | — | — | — | 90 | 90 |
| Inert firing conditions (° C./hour) | 370° C./ | 370° C./ | — | — | — | 370° C./ | 370° C./ |
| | 1 hour | 1 hour | | | | 1 hour | 1 hour |
| Firing conditions (° C./hours) in | 420° C./ | 420° C./ | — | — | — | 420° C./ | 420° C./ |
| oxygen concentration 5% and | 1.5 hours | 1.5 hours | | | | 0.5 hours | 0.5 hours |
| nitrogen concentration of 95% | | | | | | | |
| BET specific surface area (m²/g) | 89 | 35 | 37 | 395 | 40 | 18 | 16 |
| First exothermic peak (° C.) | 622 | 646 | 800 | 775 | 320 | 622 | 650 |
| Content of component derived | 9.4 | 8.7 | — | — | — | 2.8 | 2.2 |
| from second exothermic | | | | | | | |
| peak (% by weight) | | | | | | | |
| Particle concentration (particles/μL) | 2,240 | 3,150 | 68,000 | 70,000 | 29,000 | 2,240 | 3,150 |
| Integrated value of particle areas | 1,160 | 750 | 4,300 | 11,000 | 21,000 | 1,160 | 750 |
| (mm²/mg) | | | | | | | |
| Powder resistance (Ω · cm) | 8 × 10⁻² | 1 × 10⁻² | 2 × 10⁻² | 2 × 10⁻² | 2 × 10⁻² | 9 × 10⁻² | 8 × 10⁻² |
| Initial discharge capacity (mAh/g) | 159.2 | 171.9 | 175 | Film | 188.4 | 168.1 | 173.2 |
| | | | | formation | | | |
| | | | | NG | | | |
| Rate characteristics (2 C/0.2 C) | 11.5 | 15.4 | 22.5 | Film | 4.1 | 19.8 | 19.1 |
| | | | | formation | | | |
| | | | | NG | | | |
| Cycle characteristics (30th/1st) | 22.5 | 20.3 | 18.0 | Film | 0.0 | 20.1 | 22.5 |
| | | | | formation | | | |
| | | | | NG | | | |

1. A carbon material having a graphene layered structure,
a BET specific surface area of the carbon material being 1 m²/g or more and 25 m²/g or less, and
when a particle concentration of the carbon material and an integrated value of particle areas of the carbon material are measured by a flow-type particle image analyzer using an N-methyl-2-pyrrolidone solution containing 20 ppm of the carbon material, the particle concentration of the carbon material being 3,000 particles/μL or more and 50,000 particles/μL or less, and the integrated value of the particle areas of the carbon material being 1,000 mm²/mg or more and 10,000 mm²/mg or less.

2. The carbon material according to claim 1, wherein when subjected to a differential thermal analysis at a heating rate of 10° C./min, the carbon material has an exothermic peak having a peak temperature of 700° C. or lower.

3. The carbon material according to claim 1, wherein when subjected to a differential thermal analysis at a heating rate of 10° C./min, the carbon material has a first exothermic peak having a peak temperature of 500° C. or higher and 700° C. or lower and a second exothermic peak having a peak temperature of 400° C. or higher and 500° C. or lower.

4. The carbon material according to claim 3, wherein a content of a component derived from the second exothermic peak is 0.1% by weight or more and 10% by weight or less.

5. The carbon material according to claim 3, wherein a component derived from the second exothermic peak is a synthetic resin or a carbide of the synthetic resin.

6. The carbon material according to claim 5, wherein the synthetic resin contains an oxygen atom.

7. The carbon material according to claim 5, wherein the synthetic resin is at least one selected from the group consisting of (meth)acrylic resin, vinyl acetate resin, polypropylene glycol resin, and polyethylene glycol resin.

8. The carbon material according to claim 1, wherein a powder resistance of the carbon material is 0.1 Ω·cm or less.

9. A conductive aid to be used in an electrode of a power storage device, the conductive aid comprising the carbon material according to claim 1.

10. An electrode for a power storage device, the electrode comprising the conductive aid according to claim 9.

11. A power storage device comprising the electrode for a power storage device according to claim 10.
